(19) United States
(12) Patent Application Publication
(10) Pub. No.: US 2019/0102130 A1
(43) Pub. Date: Apr. 4, 2019

(54) SMART SIMULATOR FOR EXTENDED DISPLAY IDENTIFICATION DATA

(71) Applicant: IBASE TECHNOLOGY INC.

(72) Inventor: Albert Lee, Taipei City (TW)

(21) Appl. No.: 15/831,649

(22) Filed: Dec. 5, 2017

(30) Foreign Application Priority Data
Oct. 2, 2017 (TW) 106134083

(51) Int. Cl. G06F 3/14

(52) U.S. Cl. CPC G06F 3/1415; G06F 13/102; G06F 3/1423

(57) ABSTRACT

A smart simulator for extended display identification data (EDID) includes a read unit, a main control unit, a memory unit, and a transfer unit. The read unit, the memory unit, and the transfer unit are connected to the main control unit. The read unit is connected to at least one display device, and the transfer unit is connected to a display card on a main board. The display card is further connected to a main system chip. Each updated EDID is automatically and correctly transferred to the display card without re-setting display parameters while any display device is replaced by a different one so as to implement compatibility among the display devices under a specific system operation. Therefore, the smart simulator saves a great deal of manpower, prevents any inadvertent missing, and is easy to maintain, and applicable to a large scale of TV wall or digital display board.

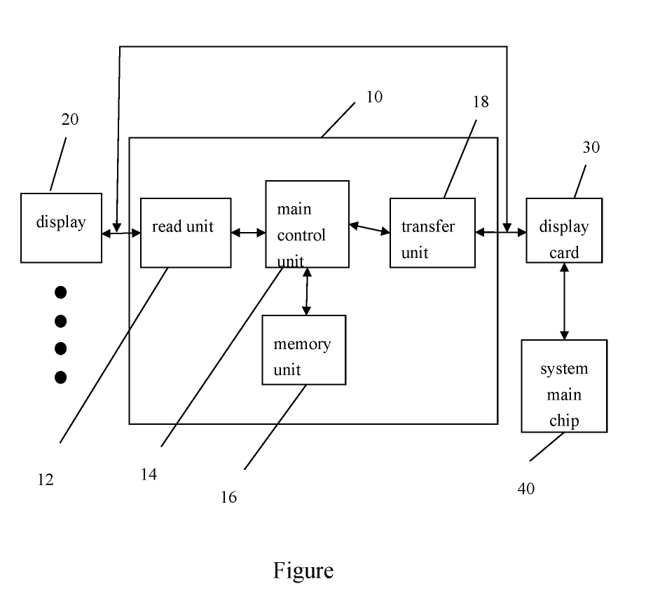

### CROSS-REFERENCE TO RELATED APPLICATION

This application claims the priority of Taiwanese patent application No. 106134083, filed on Oct. 2, 2017, which is incorporated herewith by reference.

### BACKGROUND OF THE INVENTION

### 1. Field of the Invention

The present invention generally relates to a smart simulator for extended display identification data (EDID), and more specifically to a smart simulator employing a main control unit to automatically read a EDID of at least one display, and store the EDID in a memory unit such that a system main chip in a whole system directly uses the EDID stored in the memory unit to transfer desired image to and drive the display regardless of any display being replaced by another display with a different type, thereby greatly simplifying operation procedures, avoiding inadvertent human mistakes, and overcoming incompatibility issue without a user manually setting related parameters.

### 2. The Prior Arts

In general, a computer system employs a display to implement a function of displaying images. However, each of the displays produced by the same manufacturer probably has different features like resolution or screen size. The display is provided with a respective extended display identification data (EDID) for the system to read and correctly set basic parameters of the display such as manufacturer ID, production ID code, manufacture date, elementary display parameters, hue adjustment, establishing clock I and II, specific clock reserved by the manufacturer, detailed clock description 1-4, additional flags, and check sum. Furthermore, the EDID can provide additional features, including definition of image input, largest scale of horizontal pattern, largest scale of vertical pattern, display gamma, power management, and technique support.

The EDID is usually stored in a PROM or EEPROM of the display for the computer system to read out through I2C, and the default slave address of the EDID for I2C is 0×50.

However, the user often encounters the following problems.

The first problem is that when the display is replaced and the image shown by the new display under a Windows system operation (like Window XP, Win7 or Win8) becomes smaller and does not occupy the whole screen, the user needs to correctly adjust the display parameters. For example, the resolution is altered and the zoom in/out ratio is set to “full screen” for the displayed image to occupy the whole visional range of the screen. For the ordinary user who is not familiar with the computer setting, the setting procedure is quite complicated and puzzled For instance, the user needs different and corresponding setting for an nVidia display card, an AMD_ATI display card or an Intel built-in display card provided in the computer system.

The second problem is that when a plurality of displays are used in the system like a digital display board, the drivers are installed, and software identification of the digital display board works, if any one display needs to be replaced by a new one for some reason like functional failure, it is inconvenient for the ordinary user to newly set software identification for the arrangement and sequence of all the displays.

The third problem is that error of identification may occur when the display is connected in series through an additional device like a Kernel-based Virtual Machine (KVM) or an extension device. Generally, the KVM is a full virtualization solution for Linux on ×86 hardware containing virtualization extensions (Intel VT or AMD-V). It consists of a loadable kernel module that provides the core virtualization infrastructure and a processor specific module. Moreover, if the computer is connected to the screen via the KVM or the extension device for audio and video signals, the resolution of the display is not recognized by the computer system because the transferred information is altered by the switching/splitting machine or the extension device. For instance, once a 24 inches display with an optimal display mode 1920×1080 is serial connected to the extension device, the resolution is not found in the setting of the computer, or the displayed image does not fill up the screen of the display, or results in color mismatch. In particular, any adjustment fails to fix this problem. This is because the computer fails to identify the detected EDID of the display when the KVM, HDMI, DVI splitter devices are connected in series.

Therefore, it needs a new and smart simulator for extended display identification data, which employs a main control unit to automatically read a EDID of at least one display, and store the EDID in a memory unit such that a system main chip in a whole system like the computer system directly uses the EDID stored in the memory unit to transfer desired image to and drive the display regardless of any display being replaced by a new display with another type. The user does not need to manually set the related parameters. As a result, all the operation procedures are greatly simplified, any inadvertent human mistake is avoided, and incompatibility issue is successfully overcome.

### SUMMARY OF THE INVENTION

The primary objective of the present invention is to provide a smart simulator for extended display identification data (EDID), comprising a read unit, a main control unit, a memory unit, and a transfer unit. The read unit, the memory unit, and the transfer unit are connected to and controlled by the main control unit to perform specific electrical operation. The read unit is further connected to each display, and the transfer unit is connected to the display card mounted on a mother board. The display card is further connected to a system main chip on the same mother board.

Specifically, each display has a respective EDID, and the display card is connected to each display through a specific video interface. Also, the main control unit automatically detects the display, which is connected to the read unit, and read out and transfer the EDID of each display. A display configuration data of the at least one display is established and then transferred according to a connection configuration to the read unit for every display.

Furthermore, the memory unit receives and stores the EDID for each display from the main control unit, and at the same time, also receives and stores the display configuration data from the main control unit. The transfer unit is connected to the display card, and transfers the EDID and the display configuration data based on a display data request issued by the display card under control of the main control unit.

In addition, after the system main chip executes an operation system (OS) like Windows OS provided by Microsoft Inc., and invokes the function of reading EDID from the smart simulator, the display card is driven and issues the display data request for the smart simulator such that the smart simulator receives the EDID and the display configuration data from the display card to dynamically update the corresponding driver of the at least one display. Also, through the display card and the smart simulator, at least one image is transferred to and displayed by the at least one display.

Obviously, the smart simulator of the present invention employs the main control unit to automatically read out the EDID of the display, and stores the EDID in the memory unit such that the system main chip in the whole system like the computer system directly uses the EDID stored in the memory unit to transfer desired image to and drive the display regardless of any display being replaced by another display with a different type, thereby greatly simplifying operation procedures, avoiding inadvertent human mistakes, and overcoming incompatibility issue without a user manually setting related parameters.

### BRIEF DESCRIPTION OF THE DRAWINGS

The present invention will be apparent to those skilled in the art by reading the following detailed description of a preferred embodiment thereof, with reference to the attached drawings, in which:

FIGURE is a view showing the smart simulator for extended display identification data (EDID) according to one embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention, and together with the description, serve to explain the principles of the invention.

Please refer to figure illustrating the smart simulator for extended display identification data (EDID) according one embodiment of the present invention. As shown in figure, the smart simulator 10 for EDID of the present invention is connected to at least one display 20 and a display card 30, and comprises a read unit 12, a main control unit 14, a memory unit 16, and a transfer unit 18. The read unit 12, the memory unit 16, and the transfer unit 18 are connected to and controlled by the main control unit 14 to perform specific electrical operation. In addition, the read unit 12 is connected to each display 20, and the transfer unit 18 is connected to the display card 30 mounted on a mother board (not shown). The display card 30 is further connected to a system main chip 40 such as a central processing unit (CPU) on the same mother board.

Specifically, each display 20 has a respective extended display identification data (EDID), and the display card 30 is connected to the display 20 through a video interface like VGA, D-sub, or HDMI.

The main control unit 14 automatically detects and determines whether the display 20 is connected to the read unit 12, and then reads out the EDID of the display 20. At the same time, a corresponding display configuration data is established according to the connection configuration of each display 20 to the read unit 12. Furthermore, the main control unit 14 transfers and stores the information for the EDID and the display configuration data to the memory unit 16 for the subsequent reading back process by the main control unit 14.

Additionally, the transfer unit 18 is connected to the display card 30, and under control of the main control unit, transfers the information for the EDID and the display configuration data to the display card 30 according to a display data request sent by the display card 30.

Further, the system main chip 40 which executes a specific operation system (OS) such as Windows or Linux actuates a preset read function for the smart simulator 10 of the present invention, and then drives the display card 30 to issue the above display data request to the smart simulator 10. Next, the information for the EDID and the display configuration data are received and used to dynamically update a corresponding driver for each display 20. At the same time, the at least one display 20 receives and displays at least one image transferred through the display card 30 and the smart simulator 10.

In addition, the main control unit 14 is implemented by a microcontroller (MCU) or a micro-processor, or alternatively, the read unit 12, the main control unit 14, and the transfer unit 18 are integrated into a high functional single chip.

It should be noted that the main control unit 14 can also invoke the display card 30 to directly read out the EDID of the display 20 through the video interface, thereby achieving the configuration of each display 20 for correctly displaying the transferred image.

More specifically, the main control unit 14 provides two operation modes, including an automatic learning mode and a manual mode, which are selected under the operation system executed by the main control unit 14.

Moreover, the automatic learning mode is configured to actively detect the types of the display (like CRT, DVI, HDMI, and so on), then download and store the related information (that is, EDID), which is prepared for the display card 30 to perform the request operation. When the main control unit 14 is in the automatic learning mode, the firstly or latest used display 20 is selected, stored, and prepared for the display card 30 to read out after the related information is set.

Further, the manual mode is employed to directly set the information about the resolution and type of the display 20 through a communication interface such as RS232, thereby effectively avoiding the software issue caused by incompatibility of the display 20 (like poor signal of the electrical devices) or environmental factors (like different sequence of power supply for electrical devices). Also, in the manual mode, the related information (like the resolution and the type) is provided by software, and the main control unit 14 is informed through the communication interface. After the information is set, the display card 30 is invoked to make a request for detecting all the display 20 again.

In actual application, if only one display 20 is provided, the system main chip 40 does not need to read the EDID of the display 20, but directly fetches the EDID stored in the smart simulator 10 because the EDID is previously and automatically read and stored by the smart simulator 10. The whole process is thus simple. In particular, when the user changes the display 20 with a new display 20 which has a different EDID, the system main chip 40 may just update the driver and the resolution of the image according to the EDID from the smart simulator 10 so as to correctly display the desired image on the new display 20 without any problem of incompatibility. The user does not need to make many efforts to set all the necessary parameters for the display under the operation system, and thus, the plug-in feature is implemented.

For the occasion with a plurality of displays 20 like a large scale digital display device as a display wall, the smart simulator of the present invention instantly and automatically stores the information of all the updated displays 20 regardless of the number of the displays 20 used by the user. The main system chip 40 does not care whether any display 20 is replaced, and can use the proper drivers just based on the current information stored by the smart simulator 10, thereby displaying the images on the displays 20. For example, when the system main chip 40 intends to display continuous images on the displays 20, which are arranged in a matrix to perform some effect like marquee, and when even one display 20 is damaged or broken down and replaced by a new one with a different type manufactured by another supplier, the system main chip 40 still drives all the displays 20 to show the desired images without setting any parameter again.

From the above mention, one primary feature of the present invention is that the main control unit is employed to automatically read back and store the EDID of each display to the memory unit such that the system main chip of the whole system (like a computer) may directly use the EDID to transfer all the desired images and drive all the displays regardless of any display replaced by a new one with a different type. Therefore, the user does not need to manually set the necessary parameters, the operation flow is greatly simplified, any advertent human mistake is prevented, and compatibility is successfully achieved.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A smart simulator for extended display identification data connected to at least one display and a display card, each of the at least one display having a respective extended display identification data (EDID), the display card configured on a mother board and connected to a system main chip on the same mother board, the display card connected to the at least one display through a video interface, comprising:
a read unit for being connected to the at least one display;
a main control unit connected to the read unit for automatically detecting and determining whether the at least one display is connected to the read unit, reading out the EDID of the at least one display through the read unit, transferring the EDID, and then establishing and transferring a display configuration data according to a connection configuration of each of the at least one display to the read unit;
a memory unit connected to the main control unit for receiving and storing the EDID and the display configuration data from the main control unit; and
a transfer unit connected to the main control unit and the display card for transferring the EDID and the display configuration data to the display card according to a display data request from the display card under control of the main control unit,
wherein the system main chip drives the display card to make the display data request to the smart simulator for receiving the EDID and the display configuration data from the smart simulator after the system main chip executes a system operation and a function of reading the smart simulator, a corresponding driver of the at least one display is dynamically updated, and at least one image is transferred to and displayed by the at least one display through the display and the smart simulator.

2. The smart simulator as claimed in claim 1, wherein the video interface comprises VGA, D-sub or HDMI.

3. The smart simulator as claimed in claim 1, wherein the main control unit is a microcontroller or a micro-processor.

4. The smart simulator as claimed in claim 3, wherein the read unit, the main control unit, and the transfer unit are integrated into a single chip.

5. The smart simulator as claimed in claim 1, wherein the main control unit provides an automatic learning mode and a manual mode selected under a specific operation system,
wherein when the main control unit is in the automatic learning mode, the main control unit actively detects a type of the at least one display, then downloads and stores a related information comprising the EDID prepared for the display card to perform the request operation, and the firstly or latest used display is selected, stored, and prepared for the display card to read out after the related information is set,
wherein when the main control unit is in the manual mode, a communication interface comprising RS232 is used to directly set the information of the at least one display comprising the resolution and the type, a software is employed to provide the information of the at least one display, and the communication interface informs the system main chip to invoke the display card to make a request for detecting the at least one display again after the information is set.
